(19) United States
(12) Patent Application Publication
(10) Pub. No.: US 2010/0164682 A1
(43) Pub. Date: Jul. 1, 2010

(54) IC CARD, DATA CONTROL METHOD AND PROGRAM

(76) Inventors: Yoshihito Ishibashi, Tokyo (JP); Mamoru Suzuki, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/642,693

(22) Filed: Dec. 18, 2009

(30) Foreign Application Priority Data
Dec. 26, 2008 (JP) P2008-335254

(51) Int. Cl. G06F 7/04; G06K 19/07

(52) U.S. Cl. 340/5.61; 235/492; 235/380

(57) ABSTRACT

There is provided an IC card including a recording unit (card CPU) to record display request data for requesting display on a display unit and control data for controlling display on the display unit onto card memory in response to a request from an external device, and a verification unit (display CPU) to verify data consistency by comparing predetermined control commands contained in the display request data and the control data recorded on the card memory.

### BACKGROUND OF THE INVENTION

1. Field of the Invention

The present invention relates to an IC card, a data control method and a program, and, particularly, to an IC card, a data control method and a program that verify data consistency.

2. Description of the Related Art

IC cards are widely used today that are capable of recording a large volume of information by incorporating semiconductor memory such as RAM, ROM or EEPROM. Various kinds of information such as balance information in electronic payments, electronic ticket information for transportation or amusement facilities, or coupon information used for shopping, for example, are written to IC cards through a reader/writer.

Instances of technological development for enhancing the convenience of IC cards are as follows. Japanese Unexamined Patent Application Publication No. 2003-208582, for example, discloses an IC card that has a display device such as an electronic paper or an LCD panel on its surface and is thus capable of displaying recorded information for a user. Further, Japanese Unexamined Patent Application Publication No. 2008-21176, for example, discloses an IC card that includes a means of generating power by photoelectric conversion such as a solar battery and is capable of displaying information on a display device even at a distance from a reader/writer with use of power generated by the power generating means.

### SUMMARY OF THE INVENTION

In the IC card as described above, a card control unit that controls writing and reading of data from a reader/writer and a display control unit that controls display on a display unit are included. In this case, the reader/writer performs writing and reading of data through the card control unit. Thus, authorization is necessary for data in the IC card that is accessed by the reader/writer, which is an external device, at the time of writing.

On the other hand, because the display control unit is not directly accessed by the external reader/writer, a security function is not incorporated into the display control unit in some cases. In such a case, it is necessary to make authorization unnecessary for data in the IC card that is accessed by the display control unit, so that the display control unit writes needed data to the IC card. In the IC card having such a configuration, there has been a concern that a data area for which authorization is unnecessary is tampered by a malicious third party.

In light of the foregoing, it is desirable to provide a novel and improved IC card, data control method and program capable of preventing unauthorized tampering of a data area in an IC card where authorization is unnecessary.

According to an embodiment of the present invention, there is provided an IC card including a recording unit to record display request data for requesting display on a display unit and control data for controlling display on the display unit onto card memory in response to a request from an external device, and a verification unit to verify data consistency by comparing predetermined control commands contained in the display request data and the control data recorded on the card memory.

In this configuration, the IC card records the display request data for requesting display on the display unit and the control data for controlling display on the display unit onto the card memory in response to a request from the external device, and verifies data consistency by comparing the predetermined control commands contained in the display request data and the control data. It is thereby possible to prevent unauthorized tampering of a data area in an IC card where authorization is unnecessary.

The IC card may further include a display control unit to display the display request data on the display unit and update the control data according to a verification result by the verification unit.

A control command of the display request data and a control command of the control data recorded by the recording unit in response to a request from the external device have a particular relationship, the control command of the control data may be a command for instructing the display control unit to acquire the display request data to the display unit, and the display control unit may update the control command contained in the control data so as to have a predetermined relationship with the control command contained in the display request data when acquiring the display request data from the card memory.

If the control command of the control data is a command for instructing acquisition of the display request data, the verification unit may verify whether contents of the display unit, the control command of the display request data and the control command of the control data have a particular relationship or not.

If the control command of the control data is a command for instructing acquisition of the display request data, the verification unit may verify whether contents of the display unit, the control command of the display request data and the control command of the control data have a particular relationship, and further may verify whether contents of the display request data and contents of display data for display on the display unit acquired by the display control unit match or not.

Update of the display request data may be update of secure data for which authorization is necessary, and update of the control data may be update of non-secure data for which authorization is unnecessary.

The IC card may incorporate an IC chip capable of contactless communication with an external device.

According to another embodiment of the present invention, there is provided a data control method including recording display request data for requesting display on a display unit and control data for controlling display on the display unit onto card memory in response to a request from an external device, verifying data consistency by comparing predetermined control commands contained in the display request data and the control data recorded on the card memory, and displaying the display request data on the display unit and updating the control data according to a result of the verification.

According to another embodiment of the present invention, there is provided a program causing a computer to function as an IC card including a recording unit to record display request data for requesting display on a display unit and control data for controlling display on the display unit onto card memory in response to a request from an external device, a verification unit to verify data consistency by comparing predetermined control commands contained in the display request data and the control data recorded on the card memory; and a display control unit to display the display request data on the display unit and update the control data according to a verification result by the verification unit.

According to the embodiments of the present invention described above, it is possible to prevent unauthorized tampering of a data area in an IC card where authorization is unnecessary.

### BRIEF DESCRIPTION OF THE DRAWINGS

FIG. 1 is a schematic view showing an example of an appearance of an IC card according to an embodiment of the present invention.

FIG. 2 is a block diagram showing an example of a configuration of an IC card according to the embodiment.

FIG. 3 is an explanatory view showing an example of a partial data structure of data recorded on card memory according to the embodiment.

FIG. 4 is an explanatory view showing an example of a data structure of data recorded on display memory according to the embodiment.

FIG. 5 is a sequence chart showing an example of a flow of display processing by an IC card according to the embodiment.

FIG. 6 is an explanatory view to describe verification processing by an IC card according to the embodiment.

FIG. 7 is a flowchart showing data verification processing according to the embodiment.

FIG. 8 is an example of data written to an IC card according to the embodiment.

FIG. 9 is a schematic view showing an IC card being held by a reader/writer according to the embodiment.

FIG. 10 is a block diagram showing an example of a configuration of a reader/writer according to the embodiment.

FIG. 11 is a schematic view showing an IC card according to the embodiment being held when viewed from the direction A of FIG. 9.

FIG. 12 is an explanatory view to describe light emitting patterns of a light emitting unit according to the embodiment.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

A preferred embodiment of the present invention will be described hereinafter in the following order.

[1] Object of Embodiment

[2] Outline of IC Card

[3] Internal Configuration of IC Card

[4] Display Processing by IC Card

[5] Verification Processing by IC Card

[6] Display Control by Reader/Writer

### [1] Object of Embodiment

An object of an embodiment of the present invention is described hereinafter. IC cards are widely used today that are capable of recording a large volume of information by incorporating semiconductor memory such as RAM, ROM or EEPROM. Various kinds of information such as balance information in electronic payments, electronic ticket information for transportation or amusement facilities, or coupon information used for shopping, for example, are written to IC cards through a reader/writer.

An example of technological development for enhancing the convenience of IC cards are an IC card that has a display device such as an electronic paper or an LCD panel on its surface and is thus capable of displaying recorded information for a user. Another such example is an IC card that includes a means of generating power by photoelectric conversion such as a solar battery and is capable of displaying information on a display device even at a distance from a reader/writer with use of power generated by the power generating means.

In the IC card with a display function as described above, a card control unit that controls writing and reading of data from a reader/writer and a display control unit that controls display on a display unit are included. In this case, the reader/writer performs writing and reading of data through the card control unit. Thus, authorization is necessary for data in the IC card that is accessed by the reader/writer, which is an external device, at the time of writing.

On the other hand, because the display control unit is not directly accessed by the external reader/writer, a security function is not incorporated into the display control unit in some cases. In such a case, it is necessary to make authorization unnecessary for data in the IC card that is accessed by the display control unit, so that the display control unit writes needed data to the IC card. In the IC card having such a configuration, there has been a concern that a data area for which authorization is unnecessary is tampered by a malicious third party.

In view of the foregoing, an IC card 20 according to an embodiment of the present invention has been invented. With use of the IC card 20 according to the embodiment, it is possible to prevent unauthorized tampering of a data area in an IC card where authorization is unnecessary.

### [2] Outline of IC Card

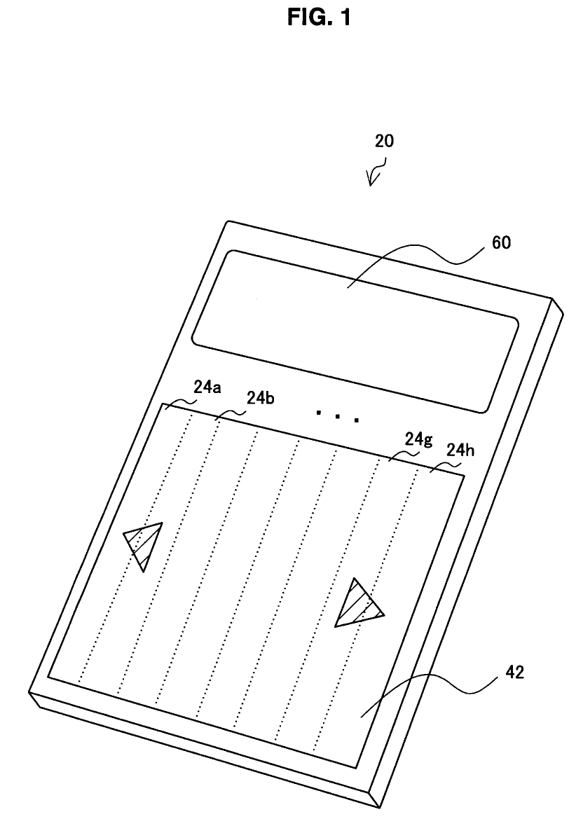

An outline of an IC card is described hereinafter with reference to FIG. 1. FIG. 1 is a schematic view showing an appearance of an IC card 20 according to an embodiment. Referring to FIG. 1, the IC card 20 includes an operating unit 42 and a display unit 60 on its outside.

The display unit 60 is configured as a display device using an LCD (Liquid Crystal Display), an OLED (Organic Light Emitting Diode) or the like, for example. The display unit 60 displays data read from memory of the IC card 20 based on control by a control unit (not shown) placed inside the IC card 20.

The operating unit 42 serves as an operating means capable of switching display contents on the display unit 60 according to a potential difference caused by photoelectric conversion. For example, the operating unit 42 may be configured as a set of solar batteries in which eight cells 24a to 24h are connected in series as shown in FIG. 1. An electromotive force of each cell of the solar battery is determined according to the load and the amount of light received. Therefore, if a user covers any of such cells with a finger, a change occurs in potential difference according to an electromotive force of each cell, and the IC card 20 can recognize the operation by the user.

For example, if the cell 24g and the cell 24h are covered in the arrangement of the cells in FIG. 1, the IC card 20 may switch the display contents on the display unit 60 in a particular direction (e.g. “next” etc.). Further, if the cell 24a and the cell 24b are covered, the IC card 20 may switch the display contents on the display unit 60 in the opposite direction (e.g. “back” etc.). The arrangement of the cells in the operating unit 42 is not limited to such an example. For example, an operation of either one direction of “next” or “back” may be recognizable in the operating unit 42.

Further, the operating unit 42 also serves as a power generating means that generates power for driving the display unit 60, as further described later.

The appearance of the IC card 20 is not limited thereto. For example, the size, position, orientation or the like of the operating unit 42 or the display unit 60 may be varied in any way according to use of the IC card 20.

The surfaces of the cells 24a to 24h of the operating unit 42 are preferably covered with a protective film for preventing scratches or breakage due to external contact or stimulus. In this case, by using a light collecting material as a material of the protective film, an electromotive force of each cell by photoelectric conversion increases, which improves the continuous display time or the allowable power consumption of the display unit 60.

### [3] Internal Configuration of IC Card

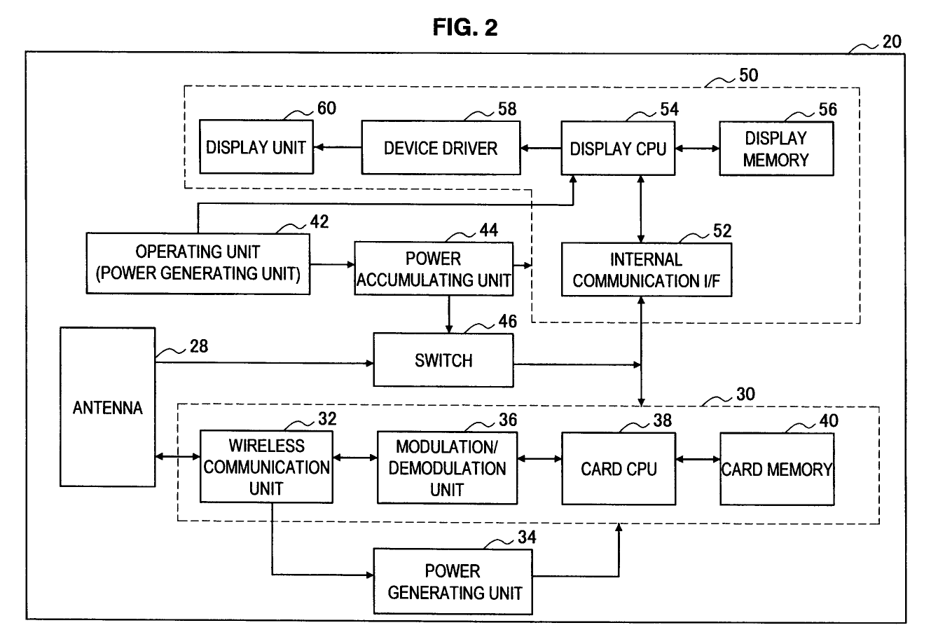

The IC card 20 has the internal configuration shown in FIG. 2, which is described hereinbelow. FIG. 2 is a block diagram showing an example of a configuration of the IC card 20. Referring to FIG. 2, the IC card 20 includes an antenna 28, an IC card module 30, a power generating unit 34, an operating unit (power generating unit) 42, a power accumulating unit 44, a switch 46 and a display module 50.

The IC card module 30 includes a wireless communication unit 32, a modulation/demodulation unit 36, a card CPU (Central Processing Unit) 38, and card memory 40. The display module 50 includes an internal communication I/F (interface) 52, a display CPU 54, display memory 56, a device driver 58 and a display unit 60.

In the case where the IC card 20 receives a signal, an electromagnetic wave received by the antenna 28 is amplified by the wireless communication unit 32 of the IC card module 30 and supplied to the modulation/demodulation unit 36. The modulation/demodulation unit 36 performs envelope detection of the modulated wave (ASK-modulated wave) supplied from the wireless communication unit 32 and demodulates the modulated wave according to BPSK (Binary Phase Shift Keying) or the like. Then, the modulation/demodulation unit 36 outputs an input signal obtained by demodulation to the card CPU 38.

The card CPU 38 controls the operation of the IC card module 30 as a whole. For example, the card CPU 38 records the data contained in the input signal onto a prescribed write location of the card memory 40 or outputs an execution result of a prescribed command designated by the input signal to the modulation/demodulation unit 36. The card memory 40 records a program to be executed by the card CPU 38, control data, application data such as electronic ticket information or the like with use of semiconductor memory such as ROM or flash memory, for example. The card CPU 38 is an example of a recording unit according to an embodiment of the present invention.

In the case where the IC card 20 transmits a signal, an output signal is output from the card CPU 38 to the modulation/demodulation unit 36. The output signal contains data read from the card memory 40, an execution result of a prescribed command or the like, for example. The modulation/demodulation unit 36 modulates the output signal according to BPSK or the like, for example, and generates an ASK-modulated wave. Then, the modulation/demodulation unit 36 outputs the generated modulated wave to the wireless communication unit 32. The wireless communication unit 32 supplies the modulated wave input from the modulation/demodulation unit 36 to the antenna 28, and the output signal is transmitted from the antenna 28 by emission of an electromagnetic wave.

The power generating unit 34 resonates the electromagnetic wave received by the antenna 28 with use of an LC circuit composed of the antenna 28 and a capacitor (not shown), for example. The power generating unit 34 then rectifies an excited alternating-current magnetic field, stabilizes it by a voltage regulator or the like, and supplies it as power of a direct-current power supply to the IC card module 30, for example.

On the other hand, the operating unit 42 is an operating means based on a potential difference caused by photoelectric conversion and also serves as a power generating means with use of a solar battery, for example, as described earlier with reference to FIG. 1. Specifically, the operating unit 42 photoelectrically converts externally received light (sunlight or light emitted from another light source) to generate power, and supplies the generated power to the power accumulating unit 44, for example.

Further, the operating unit 42 detects a potential difference corresponding to an electromotive force of each of the cells 24a to 24h shown in FIG. 1 and recognizes an operation by a user. Then, the operating unit 42 outputs an operating signal indicating descriptions of the detected operation to the display CPU 54. The operating signal may be a signal designating “next” or “back” as a direction to switch the display contents on the display unit 60, for example.

The power accumulating unit 44 accumulates the power supplied from the operating unit (power generating unit) 42 with use of a capacitor or the like, for example. The power accumulating unit 44 then supplies the accumulated power to the display module 50 and thereby drives the display module 50. The power accumulating unit 44 also supplies the accumulated power to the switch 46.

The switch 46 switches between an access from the display module 50 to the IC card module 30 and an access from the outside (the outside of the IC card 20) to the IC card module 30. For example, the switch 46 blocks an access from the display module 50 to the IC card module 30 when the antenna 28 receives an electromagnetic wave emitted from an external device such as a reader/writer. Further, for example, the switch 46 permits an access from the display module 50 to the IC card module 30 when the switch 46 receives power supply from the power accumulating unit 44 in the state where the antenna 28 does not receive an electromagnetic wave.

The display CPU 54 of the display module 50 executes a program stored in ROM (not shown) or the like, for example, and controls the operation of the display module 50 as a whole. For example, the display CPU 54 accesses the IC card module 30 through the internal communication I/F 52 and acquires the data recorded on the card memory 40. Further, the display CPU 54 records the acquired data as display data onto the display memory 56. Furthermore, the display CPU 54 acquires the display data from the display memory 56 at predetermined timing such as activation of the display module 50, for example, and displays the acquired display data on the display unit 60. The display CPU 54 is an example of a verification unit and a display control unit according to an embodiment of the present invention. Verification processing by the verification unit is described in detail later.

The internal communication I/F 52 allows an access from the display CPU 54 to the IC card module 30 by generating a signal equal to a command to be provided from the IC card module 30 to an external device, for example. The display CPU 54 can thereby acquire the data recorded on the card memory 40.

The display memory 56 stores control data, display data acquired from the card memory 40 by the display CPU 54 or the like, with use of semiconductor memory such as flash memory, for example. The descriptions of data recorded on the display memory 56 are described more specifically later.

The device driver 58 drives the display unit 60, which is a display device mounted on the IC card 20, according to control by the display CPU 54.

The display unit 60 is configured as a display device using an LCD or the like as described earlier with reference to FIG. 1. The display unit 60 displays the display data acquired from the display memory 56 by the display CPU 54, for example, on its screen.

The appearance and the internal configuration of the IC card 20, the use of which is assumed in an embodiment of the present invention, are described above with reference to FIGS. 1 and 2. As is understood from the above description, the IC card module 30 of the IC card 20 receives power supply and operates only while the antenna 28 is receiving an electromagnetic wave. On the other hand, the display module 50 of the IC card 20 can display data on the display unit 60 with use of power accumulated in the power accumulating unit 44 even if the IC card 20 is located in a place away from a reader/writer, for example.

Although the case where the IC card 20 is a contactless IC card is described above by way of illustration, the IC card 20 is not limited to a contactless IC card. If the IC card 20 is a contact IC card, a terminal and a communication unit, instead of the antenna 28 and the wireless communication unit 32, may be mounted on the IC card 20, for example.

A structure of data related to the embodiment, among data recorded on the card memory 40 and the display memory 56 of the IC card 20, is described hereinafter.

### <Exemplary Data Structure of Card Memory>

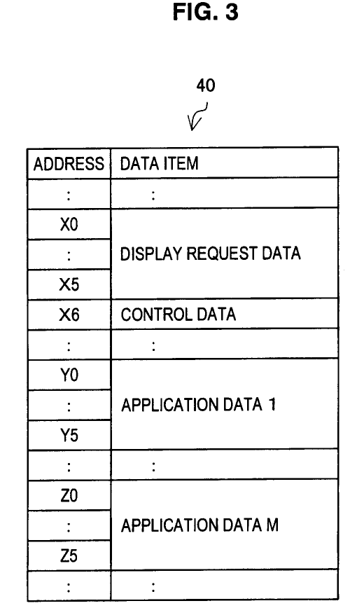

FIG. 3 is an explanatory view showing an example of a partial data structure of data recorded on the card memory 40 shown in FIG. 2.

Referring to FIG. 3, display request data is recorded at addresses X0 to X5, control data is recorded at an address X6, application data 1 to application data M are recorded at addresses Y0 to T5 and subsequent addresses, respectively on the card memory 40.

The display request data is data for making a request for display from the IC card module 30 (or an external device) to the display module 50. In response to an instruction from an external device, the card CPU 38 of the IC card module 30 writes the display request data related to given application such as an electronic ticket or an electronic coupon to the addresses X0 to X5. The display request data may be any data that can be displayed on the display unit 60 of the display module 50, such as text data or bitmap data, for example.

The control data is data for controlling a display request from the IC card module 30 to the display module 50 and a response. For example, in response to an instruction from an external device, the card CPU 38 of the IC card module 30 writes data requested to be displayed onto the display request data and further writes a prescribed bit string designating acquisition of the display request data by the display module 50 onto the control data.

Further, the display CPU 54 of the display module 50 writes a prescribed bit string indicating a success of acquisition of the display request data onto the control data when acquisition of the display request data succeeds, for example. On the other hand, the display CPU 54 writes a prescribed bit string (error code) indicating a failure of acquisition of the display request data onto the control data when acquisition of the display request data fails, for example. The kind of an error (a data length error, a command error etc.) may be identifiable by the value of an error code, for example.

With use of such control data, the status of data coordination between the IC card module 30 and the display module 50 is shared with an external device. It is thereby possible to prevent data inconsistency between the IC card module 30 and the display module 50 by inhibiting writing of new data from an external device until acquisition of the display request data by the display module 50 is completed, for example.

The application data 1 to the application data M are arbitrary data related to various applications provided by the IC card 20. The application data 1 to the application data M may contain balance information, electronic ticket information, coupon information or the like, for example, as described earlier.

The balance information that is likely to be used in common by a plurality of applications may be held at a particular address which is different from the application data 1 to the application data M, not restricted to the example of FIG. 3. Further, the card memory 40 may store any data other than the data shown in FIG. 3.

### <Exemplary Data Structure of Display Memory>

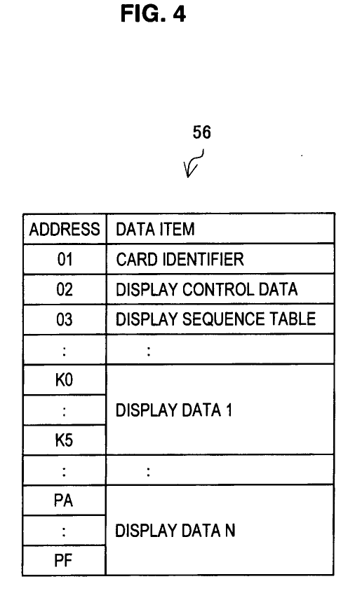

FIG. 4 is an explanatory view showing an example of a data structure of data recorded on the display memory 56 shown in FIG. 2.

Referring to FIG. 4, a card identifier is recorded at an address 01, display control data is recorded at an address 02, a display sequence table is recorded at an address 03, and display data 1 to display data N are recorded at addresses K0 to K5 and subsequent addresses, respectively on the display memory 56.

The card identifier is an identifier for identifying an individual piece of the IC card module 30 to be accessed by the display module 50. Generally, when an external device makes an access to the IC card, a polling command is issued from the external device, and the card identifier is acquired in response thereto. The external device can thereby identify the IC card to be communicated with from a plurality of IC cards.

On the other hand, in this embodiment, a combination of the IC card module 30 and the display module 50 that are incorporated in the IC card 20 does not change. Thus, by recording the card identifier that identifies an individual piece of the IC card module 30 onto the display memory 56 in advance, it is possible to eliminate the polling processing and thereby reduce the power consumption and the processing time in the IC card 20. The card identifier may be acquired by a polling command upon initial startup after the display module 50 is incorporated into the IC card 20, or may be written by a manufacturing device during manufacture.

The display control data is data for controlling display processing by the display module 50. For example, the display control data contains address data such as a memory address at which the control data is stored in the card memory 40 of the IC card module 30.

The display sequence table defines in what sequence the display data 1 to the display data N at the addresses K0 to K5 and subsequent addresses are displayed on the display unit 60. The display sequence table may be data that lists the addresses (or block numbers etc.) of the display data 1 to the display data N in the sequence of displaying the data on the display unit 60, for example. Further, the display sequence table may contain data that defines the kind of display sequence such as a sequence of memory or a sequence of date.

Furthermore, the display sequence table may contain an address of initial display data to be displayed initially on the display unit 60. A plurality of display sequence tables may be recorded on the display memory 56. In this case, serial numbers may be assigned to the respective display sequence tables, for example, and a display sequence of data on the display unit 60 may be selected as appropriate from a plurality of patterns.

The display data 1 to the display data N are data that can be displayed on the display unit 60. As described earlier, the display CPU 54 records the display request data acquired from the card memory 40 of the IC card module 30 as display data onto any memory location of the display data 1 to the display data N. Then, the display data is read by the display CPU 54 in the sequence according to the display sequence table and displayed on the display unit 60.

An example of the data structure of data that can be recorded on the card memory 40 and the display memory 56 of the IC card 20 is described above with reference to FIGS. 3 and 4. Hereinafter, display processing executed by the IC card 20 is described.

### [4] Display Processing by IC Card

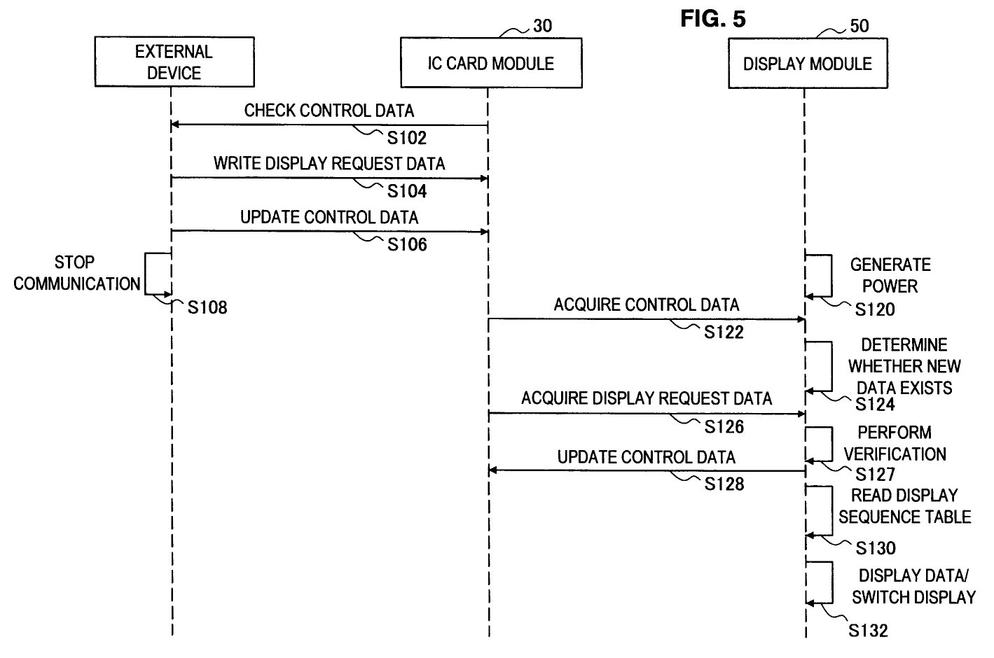

FIG. 5 is a sequence chart showing an example of a flow of display processing by the IC card 20. FIG. 5 shows processing after writing of data from an external device such as a reader/writer to the IC card 20 is started until the data is displayed on the display unit 60 of the IC card 20.

Referring to FIG. 5, the external device first acquires the control data from the card memory 40 in the IC card module 30 and checks whether the display request data that is not yet captured into the display module 50 remains or not (S102). If the control data indicates that there remains the uncaptured display request data, the external device cancels the subsequent processing. On the other hand, there is no uncaptured display request data remaining, the display request data is written to the card memory 40 of the IC card module 30 in response to an instruction from the external device (S104).

For efficient processing, it is suitable to write the application data corresponding to the display request data simultaneously to the card memory 40. Further, the external device updates the control data on the card memory 40 to a prescribed bit string that designates data acquisition by the display module 50 (S106). After that, the external device stops emission of an electromagnetic wave from its own device and waits for acquisition of the display request data by the display module 50 (S108).

After that, when the operating unit (power generating unit) 42 of the IC card 20 receives light and power high enough to drive the display module 50 is accumulated in the power accumulating unit 44, the display module 50 is activated (S120). Then, the display CPU 54 of the display module 50 accesses the IC card module 30 and acquires the control data recorded on the card memory 40 (S122).

The display CPU 54 then determines whether new display request data is written or not by referring to the bit string of the control data (S124). If the new display request data is not written, the processing in the subsequent steps S126 and S128 is skipped. If, on the other hand, the new display request data is written, the display CPU 54 accesses the IC card module 30 and acquires the display request data recorded on the card memory 40 (S126).

Then, data consistency is verified by comparing control commands contained in the control data acquired in the step S122 and the display request data acquired in the step S126 (S127). Data verification processing in the step S127 is described in detail later.

Then, if the display CPU 54 successfully acquires the display request data, the display CPU 54 updates the control data on the card memory 40 to a prescribed bit string that indicates a success of acquisition of the display request data (S128).

Then, the display CPU 54 reads the display sequence table from the display memory 56 (S130) and displays the display data 1 to N on the display unit 60 sequentially according to the display sequence table (S132). At this time, if the display CPU 54 detects that an operation designating switching of display contents is performed through the operating unit 42, the display CPU 54 switches the display data being displayed on the display unit 60 into other display data.

Compared to the communication processing from S122 to S128 by the display module 50, a high processing speed is not demanded for the display processing after S130. For example, while a processing speed of the communication processing is about several tens of MHz, a processing speed of the display processing can be about several tens of kHz. Therefore, the display module 50 can save power consumption by temporarily increasing a processing clock speed only during the steps S122 to S128. The IC card 20 can thereby display the data written from the external device for a user.

### [5] Verification Processing by IC Card

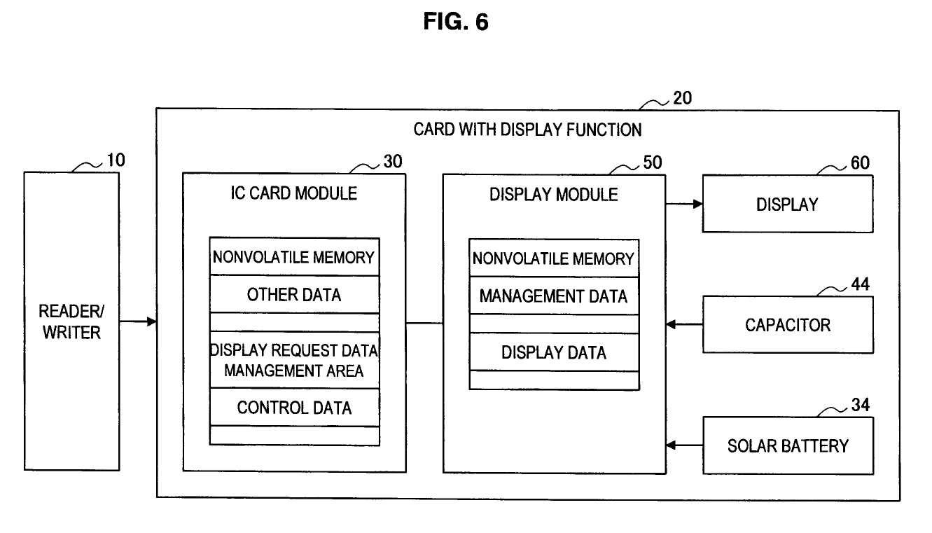

The display processing by the IC card 20 is described in the foregoing. In the following, verification processing by the IC card 20 is described. As descried earlier, the verification processing is executed by the display CPU 54, which is an example of a verification unit. FIG. 6 is an explanatory view to describe verification processing by the IC card. As described above, an external device such as a reader/writer (which is referred to hereinafter as a reader/writer) reads memory in the IC card module or writes data into the memory. Thus, the reader/writer can access only the IC card module, and it is unable to directly rewrite the memory in the display module.

Referring to FIG. 6, the reader/writer 10 reads and writes a nonvolatile memory part of the IC card module 30. Further, the display module 50 reads necessary information from the IC card module 30 and stores the data into nonvolatile memory within the display module 50. The display module 50 then transfers the stored display image data to a display so as to perform a display operation or switch display in response to input of a photovoltaic switch.

In a contactless communication system between the reader/writer 10 and the IC card 20, a plurality of access methods can be defined for one file. For example, in the IC card 20, authorization is necessary upon writing and unnecessary upon reading in a display request data management area.

On the other hand, in the case where a security function is not incorporated into the display module 50 that is not directly accessed by the reader/writer, control data that is accessed by the display module 50 is non-secure data for which authorization is unnecessary. Generally, if a security function is incorporated into an LSI (Large Scale Integration) to be mounted on an IC card, costs for manufacturing the IC card become higher. Thus, there are cases where a security function is not incorporated into a display LSI (display module) that is not accessed by an external device.

When control data of the IC card module is non-secure data, there is a concern that the control data is corrupted into an improper state or rewritten to a command different from original information by a malicious third party. If the control data is corrupted, some action can be taken to deal with the problem by detecting the improper state and interrupting processing, for example. However, if the control data is rewritten to information different from original information, which is in an improper state, there is a possibility that it is determined to be proper information and processing different from appropriate processing is executed.

Examples of commands written to control data are as follows.

(1) Setting of Display Data

(2) Deletion of Display Data

(3) Setting of Display Table

(4) Setting of Access Area Address

The cases where the respective commands are rewritten by a malicious third party are described hereinafter.

### (1) Setting of Display Data

In the case where a command for setting display data is written to control data by a malicious third party, the display module 50 captures display request data in the IC card module 30 and writes the data into the memory in the display module 50. Then, the data that has been written to the memory in the display module 50 before is overwritten and lost.

Further, in order to make sure to write the display request data into the memory in the display module 50, it is necessary to supply stable power to the display module 50. For example, there may be a case where a malicious third party rewrites the control data from information indicating that data capture is done to information indicating that display request data exists and further shuts off power of the display module in the process that the display module captures the display request data. Generally, if power runs out in the process of rewriting nonvolatile memory, data writing failure or the like occurs. Therefore, in the event of a fraudulent act by a malicious third party as described above, there is a possibility that writing of the display request data fails or data being written becomes improper data.

### (2) Deletion of Display Data

In the case where a command for requesting deletion of display data is written to control data by a malicious third party, the display module 50 deletes display request data from the memory in the display module 50.

### (3) Setting of Display Table

In the case where a command for rewriting a display table is written to control data by a malicious third party, a display sequence is rewritten to an unexpected sequence.

### (4) Setting of Access Area Address

In the case where a stored address of a data area to be accessed, such as balance, display data or control data, is rewritten by a malicious third party, an access is made to a data area corresponding to the rewritten address next time. As a result, a data address is changed to an area where a malicious third party can freely access. Normally, a data area in a card is entirely managed by a person having access authority, and there is no way of creating an area where a malicious third party can freely use. However, if an authorized person gives an area to another person, for example, there is a possibility that an attack is made by making use of the given area.

In order to prevent unauthorized data tampering by a malicious third party as described above, the display CPU 54 in the display module 50 verifies data consistency by comparing predetermined commands contained in the display request data and the control data recorded on the card memory. Because the display request data recorded on the card memory can be rewritten by an authorized person only, it is possible to verify whether the control data is rewritten by a malicious third party by verifying data consistency and thereby prevent unauthorized data tampering.

One method of verifying data consistency is to give certain relevance to a response code that is contained in the control data and a command code that is contained in the display request data. The response code that is contained in the control data is data that is generally rewritten when the display module 50 captures the control data. The command code that is contained in the display request data is a code that is generally unchanged after data is written by a reader/writer.

When data is written by a reader/writer, the response code of the control data and the command code of the display request data are set to be the same value. Then, when the display module captures the display request data, the response code of the control data is rewritten so as to have a predetermined relationship with the command code of the display request data.

For example, when the display module captures the display request data, “1” is added to the response code of the control data. The relationship between the response code of the control data and the command code of the display request data is thereby either the same or a difference of “1”. Therefore, it is possible to determine whether the control data is rewritten by a malicious third party by verifying whether the both codes have a particular relationship (i.e. the same) or a predetermined relationship (i.e. with “1” added) in the display CPU 54.

However, there is a possibility that a malicious third party changes the response code of the control data which has been set to indicate a processed state by the display CPU 54 back to the response code indicating an unprocessed state. In such a case, the display CPU 54 wrongly intends to capture the same display request data again in spite of that the display request data has been captured once. Particularly, if power (light) is shut off when writing data into the memory in the display module 50, the data in the display module 50 can be corrupted as described above.

In order to prevent the above-described data tampering, the control data in the IC card module 30 is read out, and if the data is not yet captured (i.e. an unprocessed state), the display request data is read out. Then, a comparison is made between the command code contained in the display request data and the response code contained in the control data in order to verify their consistency, as described earlier. As a result of verification, if it is determined that there is data consistency, such as when the command code and the response code are the same, a further comparison is made between the display request data and display data written to the memory in the display module 50. If the display request data and the display data in the display module 50 are the same, it is confirmed that the data is already captured. In this case, the display CPU 54 rewrites the response code from an unprocessed state to a processed state without executing data writing processing.

Further, in the case where the command contained in the control data is a command for deleting display image data, if the display data is already deleted, deletion processing is not executed. Furthermore, in the case where the command is a command for instructing rewrite of a display table, if the display table requested to be rewritten is already written, rewrite of data in the display table is not performed. In the case where the command is a command for setting an access area address, if the access area is already set, setting processing is not executed.

Because of a possibility of memory corruption due to power shortage during writing, a comparison is made between data after change and requested data in the case where processing that involves a change in data is instructed. If it is determined that no change is made to the data even after executing the requested processing, the processing is not executed.

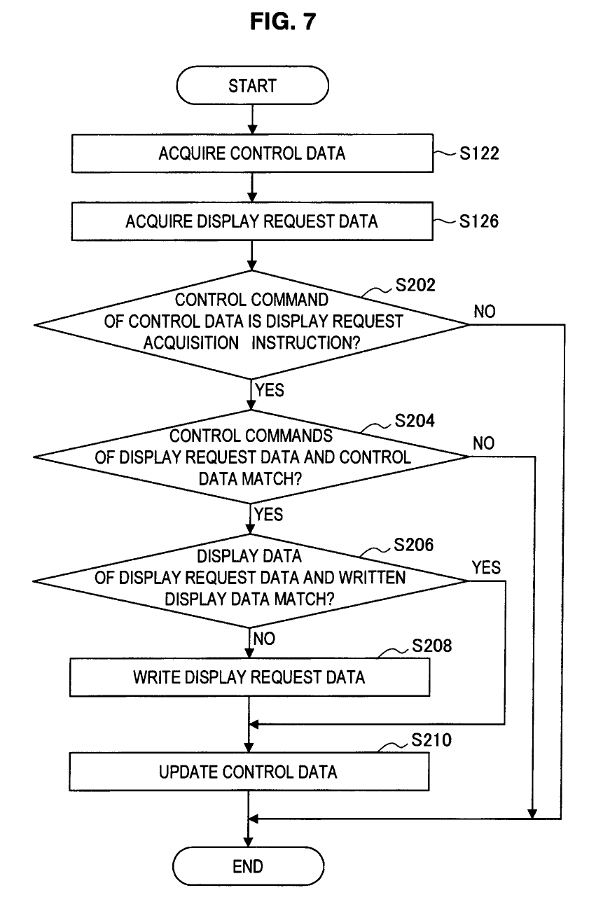

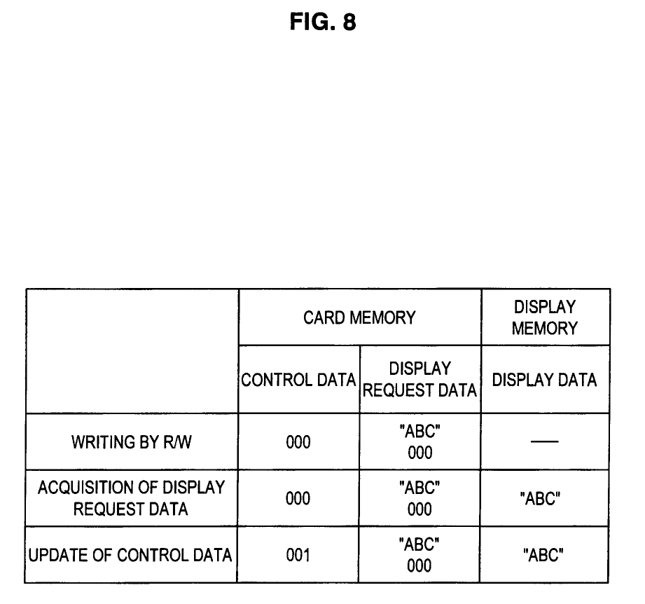

The above-described data verification processing is specifically described hereinafter with reference to FIGS. 7 and 8. FIG. 7 is a flowchart showing the data verification processing. The verification processing shown in FIG. 7 is described by referring to FIG. 8 as appropriate.

Referring to FIG. 7, the display CPU 54 first acquires control data in the IC card module 30 (S122). Next, the display CPU 54 acquires display request data in the IC card module 30 (S126).

Then, it is determined whether a control command (response code) of the control data is data to instruct acquisition of a display request (S202). If it is determined in the step 202 that the response code of the control data is data to instruct acquisition of a display request, it is further determined whether a control command (command code) of the display request data acquired in the step S126 and the control command (response code) of the control data acquired in the step S122 match or not (S204).

Referring to FIG. 8, if data is written by a reader/writer (R/W), the response code of the control data is “000”, and the command code of the display request data is “000”, which are the same. Further, display data that is contained in the display request data is “ABC”, for example.

Referring back to FIG. 7, if it is determined in the step S204 that the control commands of the display request data and the control data match, it is further determined whether the display data that is contained in the display request data and display data that is already written in the display module 50 match or not (S206). If it is determined in the step S206 that the display data do not match, the display request data is written into the display module 50 (S208). After that, the response code of the control data is updated (S210).

Referring again to FIG. 8, the display CPU 54 updates the control data after acquiring the display request data. At this time, the display CPU 54 rewrites the response code of the control data to a value obtained by adding “1” to the command code of the display request data. Further, the display CPU 54 writes the display data into the memory in the display module 50.

Accordingly, if the command code of the display request data is “000” and the response code of the control data is “001” in the step S204, it indicates that the display request data is written into the memory in the display CPU 54.

Referring back to FIG. 7, if it is determined in the step S206 that the display data match, the response code of the control data is updated without writing the display request data (S210).

Referring again to FIG. 8, generally, if the display data is written into the memory in the display module 50, the response code of the control data is updated to a value “001”, which is obtained by adding “1” to the command code “000” of the display request data. However, there is a possibility that the response code of the control data is rewritten to “000” by a malicious third party in spite of that the display data is already written.

In such a case, because the command code “000” of the display request data and the response code “000” of the control data are the same, the display CPU 54 wrongly determines that the data is unprocessed and intends to write the display data into the memory in the display module 50. However, even if the control commands match, consistency between the contents of the display request data and the display data in the display module 50 is determined in the step S206. Based on the determination, if the display request data is already written, the update of the control data is executed without executing the data writing in the step S208. In this case, the response code of the control data changes from “000” indicating an unprocessed state to “001” indicating a processed state.

As described above, the IC card 20 according to the embodiment verifies data consistency by comparing the control commands contained in the control data and the display request data in the case where the control data is non-secure data. It is thereby possible to prevent unauthorized tampering by a malicious third party.

### [6] Display Control by Reader/Writer

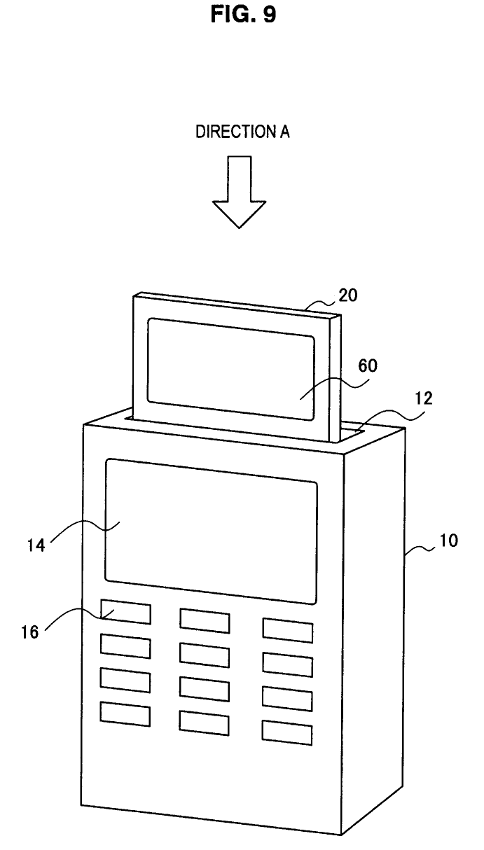

Display control by the reader/writer 10 on the IC card 20 is described hereinafter. FIG. 9 is a schematic view showing the IC card 20 being held by the IC card holding unit 12 of the reader/writer 10. Referring to FIG. 9, the reader/writer 10 includes the IC card holding unit 12, a display unit 14 and a key input unit 16 appearing on its outside, for example.

Referring to FIG. 9, the IC card 20 is inserted into the IC card holding unit 12 of the reader/writer 10. At this time, the position of the IC card 20 is adjusted in such a way that the display unit 60 is visible for a user of the reader/writer 10 and external light does not reach the operating unit 42.

The IC card holding unit 12 holds the IC card when the reader/writer 10 writes given information such as balance information, electronic ticket information or coupon information into the IC card. The depth of the IC card holding unit 12 is adjusted in such a way that a display unit of an IC card being held by the IC card holding unit 12 is visible from the outside of the reader/writer 10, as described in detail later. Although the shape of the IC card holding unit 12 is a pocket-like shape to which an IC card can be inserted from above, the shape of the IC card holding unit 12 is not limited thereto and may be another shape.

The display unit 14 displays given information, such as information related to control of the reader/writer 10, information read from an IC card or information written to an IC card, for a user.

The key input unit 16 includes a button, a switch, a lever, a key or the like for a user to operate the reader/writer 10. The display unit 14 and the key input unit 16 may be integrated with use of a touch panel or the like, for example.

Further, an external communication device that allows the reader/writer 10 to communicate with an external device, a printing device that prints out given information onto a paper medium (both not shown) or the like may be additionally mounted on the reader/writer 10 according to need.

Although FIG. 9 shows a portable electronic ticket issuing machine as an example of the reader/writer 10, the reader/writer 10 is not limited to such an example. For example, the reader/writer 10 may be any reader/writer for an IC card, such as a stationary electronic ticket issuing machine, an electronic payment terminal or an electronic coupon issuing machine, for example.

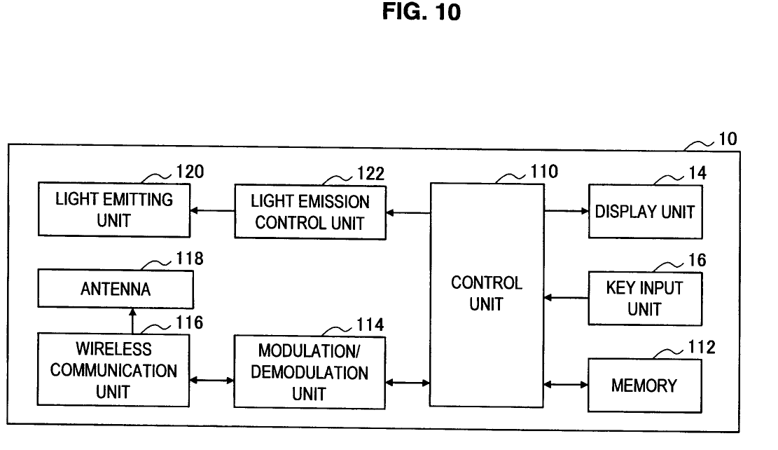

Referring to FIG. 10, the reader/writer 10 includes a display unit 14, a key input unit 16, a control unit 110, memory 112, a modulation/demodulation unit 114, a wireless communication unit 116, an antenna 118, a light emitting unit 120, a light emission adjusting unit 122 and so on.

The control unit 110 executes a program recorded on the memory 112, for example, by using an arithmetic unit such as a CPU or an MPU, and thereby controls the operation of the reader/writer 10 as a whole. For example, the control unit 110 transmits a prescribed data write command to the IC card 20 through the modulation/demodulation unit 114, the wireless communication unit 116 and the antenna 118. The function of the control unit 110 related to features of the reader/writer 10 according to the embodiment is described more specifically later. The memory 112 stores a program to be executed by the control unit 110, control data or the like by using semiconductor memory such as ROM or flash memory, for example.

The modulation/demodulation unit 114, the wireless communication unit 116 and the antenna 118 serve as a communication module by which the reader/writer 10 transmits a prescribed command to the IC card 20 and the reader/writer 10 receives a response from the IC card 20.

For example, in the case where the reader/writer 10 writes data to the IC card 20, an output signal that contains a command designating data writing and data is output from the control unit 110 to the modulation/demodulation unit 114. The modulation/demodulation unit 114 modulates the output signal according to BPSK or the like, for example, and generates an ASK-modulated wave. Then, the modulation/demodulation unit 114 outputs the generated modulated wave to the wireless communication unit 116. The wireless communication unit 116 supplies the modulated wave input from the modulation/demodulation unit 114 to the antenna 118, and the output signal is transmitted from the antenna 118 by emission of an electromagnetic wave.

Further, in the case where the reader/writer 10 reads data from the IC card 20, a command designating data reading is transmitted to the IC card 20, as in the case of data writing described above. Then, a response signal containing prescribed data is transmitted by return from the IC card 20 and received by the antenna 118. Then, the response signal (ASK-modulated wave) received by the antenna 118 is amplified by the wireless communication unit 116 and supplied to the modulation/demodulation unit 114. The modulation/demodulation unit 114 performs envelope detection of the modulated wave supplied from the wireless communication unit 116 and demodulates the modulated wave according to BPSK or the like, for example. Then, the modulation/demodulation unit 114 outputs the demodulated response signal to the control unit 110.

The light emitting unit 120 supplies light to an operating means that is mounted on the IC card held by the IC card holding unit 12 shown in FIG. 9 and is capable of switching display contents on the display unit of the IC card by a potential difference occurring due to photoelectric conversion. The operating means of the IC card corresponds to the operating unit (second power generating unit) 42 of the IC card 20, which is described earlier with reference to FIG. 1, for example. Specifically, the light emitting unit 120 includes a light emitting element such as an LED (Light Emitting Diode) or a light emitter such as a fluorescent tube or an electric bulb, for example, which is capable of applying light to the operating unit 42 of the IC card 20 that is held by the IC card holding unit 12, for example. Then, the light emitting unit 120 applies light to the operating means of the IC card according control by the light emission adjusting unit 122, which is described later, and drives the display module of the IC card.

Further, the light emitting unit 120 can supply light to the operating means by a first light emitting pattern that drives the display unit of the IC card and a second light emitting pattern that switches display contents of the display unit of the IC card.

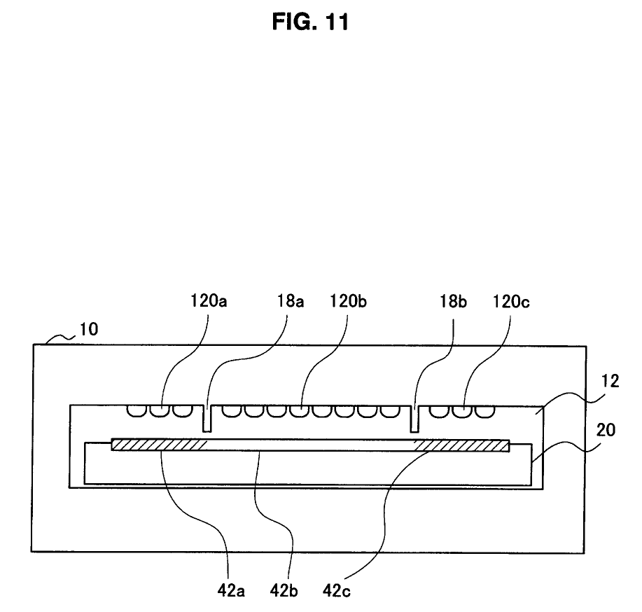

FIG. 11 is a schematic view showing the state where the inside of the IC card holding unit 12 is viewed from the direction A of FIG. 9. Referring to FIG. 11, the IC card 20 that is held by the IC card holding unit 12 of the reader/writer 10 is shown with the surface having the operating unit 42 (which is referred to hereinafter as an operating surface) facing up.

In FIG. 11, the operating unit 42 is divided into three operating sections 42a, 42b and 42c. The first operating section 42a corresponds to the cell 24g and the cell 24h of the operating unit 42 shown in FIG. 1, for example. The second operating section 42b corresponds to the cell 24c to the cell 24f of the operating unit 42 shown in FIG. 1, for example. The third operating section 42c corresponds to the cell 24a and the cell 24b of the operating unit 42 shown in FIG. 1, for example.

On the other hand, a plurality of light emitting elements included in the light emitting unit 120 are placed on the surface on the inside of the IC card holding unit 12 of the reader/writer 10 which is placed opposite to the operating surface of the IC card 20. The light emitting elements are divided into three light emitting sections 120a, 120b and 120c by dividers 18a and 18b. The first light emitting section 120a is placed opposite to the first operating section 42a of the IC card 20. The second light emitting section 120b is placed opposite to the second operating section 42b of the IC card 20. The third light emitting section 120c is placed opposite to the third operating section 42c of the IC card 20.

With such three light emitting sections 120a, 120b and 120c, the light emitting unit 120 can apply light to the operating unit 42 of the IC card 20 with a prescribed light emitting pattern so as to switch the contents displayed on the display unit 60 of the IC card 20.

In FIG. 11, the divider 18a is placed in order that light from the first light emitting section 120a does not reach the second operating section 42b, and light from the second light emitting section 120b does not reach the first operating section 42a. Likewise, the divider 18b is placed in order that light from the second light emitting section 120b does not reach the third operating section 42c, and light from the third light emitting section 120c does not reach the second operating section 42b.

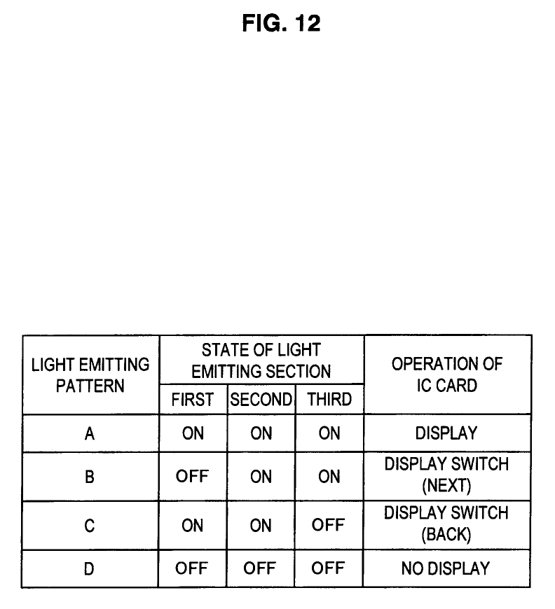

FIG. 12 is an explanatory view to describe a relationship between light emitting patterns by the light emitting unit 120 and details of an operation detected by the operating unit 42 of the IC card 20.

Referring to FIG. 12, four light emitting patterns A to D are defined. The light emitting pattern A indicates the state where all of the first light emitting section 120a, the second light emitting section 120b and the third light emitting section 120c are lighting up. In this pattern, light is applied to all the operating sections 42a to 42c of the operating unit 42 of the IC card 20, and therefore the IC card 20 can drive the display unit 60 by using power generated by the operating unit 42.

The light emitting pattern B indicates the state where the first light emitting section 120a is lighting off and the second light emitting section 120b and the third light emitting section 120c are lighting up. In this pattern, light is not applied to the first operating section 42a of the operating unit 42 of the IC card 20, and light is applied to the second operating section 42b and the third operating section 42c of the operating unit 42 of the IC card 20. This is the same state as when the cell 24g and the cell 24h are covered in the operating unit 42 of the IC card 20, and the IC card 20 switches the display contents on the display unit 60 in the direction of “next”, for example.

The light emitting pattern C indicates the state where the first light emitting section 120a and the second light emitting section 120b are lighting up, and the third light emitting section 120c is lighting off. In this pattern, light is applied to the first operating section 42a and the second operating section 42b of the operating unit 42 of the IC card 20, and light is not applied to the third operating section 42c of the operating unit 42 of the IC card 20. This is the same state as when the cell 24a and the cell 24b are covered in the operating unit 42 of the IC card 20, and the IC card 20 switches the display contents on the display unit 60 in the direction of “back”, for example.

The light emitting pattern D indicates the state where all of the first light emitting section 120a, the second light emitting section 120b and the third light emitting section 120c are lighting off. In this pattern, light is not applied to any of the operating sections 42a to 42c of the operating unit 42 of the IC card 20, and therefore the IC card 20 cannot drive the display unit 60 unless power accumulated in the power accumulating unit 44 remains, for example.

FIG. 12 shows the case of controlling supply of light to the IC card 20 by turning on or off the light emitting elements included in the light emitting unit 120 with respect to each light emitting section. However, a method of controlling supply of light to the IC card 20 is not limited thereto. For example, a shutter may be placed at the front of each light emitting section, and supply of light to the IC card 20 may be controlled by opening or closing the shutter.

The number, shape and position of light emitting sections of the light emitting unit 120 and the number of dividers can be set according to the specifications of the number, shape and position of operating sections of the operating unit 42 of the IC card 20 or the like. For example, if only the “next” operation is recognizable in the operating unit 42, the number of light emitting sections of the light emitting unit 120 may be two, and the number of dividers may be one. Further, a plurality of light emitting patterns may be prepared for one operation in order to be compatible with use of a plurality of different IC cards in the reader/writer 10, for example.

Referring back to FIG. 10, the light emission adjusting unit 122 allows the data recorded on the IC card 20 by the control unit 110 through the modulation/demodulation unit 114, the wireless communication unit 116 and the antenna 118 to be displayed on the display unit 60 of the IC card 20 by adjusting the number of times of emitting light or the light emitting pattern by the light emitting unit 120. Specifically, after the control unit 110 records given data onto the IC card 20, the light emission adjusting unit 122 acquires information about a write location of the data on the memory of the IC card 20 from the control unit 110.

Next, the light emission adjusting unit 122 determines the number of times of emitting light or the light emitting pattern by the light emitting unit 120 according to the acquired write location. After that, the light emission adjusting unit 122 causes the light emitting unit 120 to supply light to the IC card 20 by the determined number of times of emitting light or light emitting pattern. As a result, the contents displayed on the display unit 60 of the IC card 20 are switched to the data recorded on the IC card 20 by the control unit 110. A user can thereby check the data written to the IC card 20 by looking at the display unit 60 of the IC card 20 without taking off the IC card 20 from the reader/writer 10 for operation. The function of the light emission adjusting unit 122 described above may be directly executed by the control unit 110.

Further, while the control unit 110 performs communication with the IC card 20 through the modulation/demodulation unit 114, the wireless communication unit 116 and the antenna 118, the light emission adjusting unit 122 stops supply of light from the light emitting unit 120 to the IC card 20 by applying the light emitting pattern D of FIG. 12, for example. Likewise, while light is supplied from the light emitting unit 120 to the IC card 20 under control of the light emission adjusting unit 122, the control unit 110 stops communication with the IC card 20. It is thereby possible to prevent the occurrence of processing error or data inconsistency within the IC card 20 due to simultaneous access to the IC card module 30 between the display module 50 and the external device (the reader/writer 10) in the IC card 20.

Consider, for example, the case where control data is rewritten by a malicious third party in the state when data has been written by the reader/writer 10 and the display module 50 of the IC card 20 does not yet capture the display request data. In such a case, although the response code of the control data is “000” indicating an unprocessed state, there is a possibility that the response code of the control data is rewritten to “001” indicating a processed state by a malicious third party.

It is when a station staff is manipulating the above-described reader/writer 10 or a ticket issuing machine having a function of the reader/writer 10 is issuing a ticket that a command to instruct writing is written to the control data in the IC card module 30. In such a case, light control is performed by the reader/writer 10, so that data is written without fail. Therefore, there is almost no possibility that the control data is rewritten by a malicious third party in the process of writing data.

It should be understood by those skilled in the art that various modifications, combinations, sub-combinations and alterations may occur depending on design requirements and other factors insofar as they are within the scope of the appended claims or the equivalents thereof.

Although the case where the reader/writer 10 is a portable reader/writer is mainly described above, the reader/writer 10 may be any of a portable type and a stationary type. Likewise, although the case where the IC card 20 is a contactless IC card is mainly described above, the IC card 20 may be any of a contact type and a contactless type.

Further, a series of processing by the reader/writer 10 or the IC card 20 described above may be implemented by hardware or software. In the case of executing a series of or a part of processing by software, a program constituting the software is prestored in ROM, loaded to RAM upon execution and then executed by a CPU.

The present application contains subject matter related to that disclosed in Japanese Priority Patent Application JP 2008-335254 filed in the Japan Patent Office on Dec. 26, 2008, the entire content of which is hereby incorporated by reference.

What is claimed is:

1. An IC card comprising:
a recording unit to record display request data for requesting display on a display unit and control data for controlling display on the display unit onto card memory in response to a request from an external device; and
a verification unit to verify data consistency by comparing predetermined control commands contained in the display request data and the control data recorded on the card memory.

2. The IC card according to claim 1, further comprising:
a display control unit to display the display request data on the display unit and update the control data according to a verification result by the verification unit.

3. The IC card according to claim 1, wherein
a control command of the display request data and a control command of the control data recorded by the recording unit in response to a request from the external device have a particular relationship,
the control command of the control data is a command for instructing the display control unit to acquire the display request data to the display unit, and
the display control unit updates the control command contained in the control data so as to have a predetermined relationship with the control command contained in the display request data when acquiring the display request data from the card memory.

4. The IC card according to claim 1, wherein if the control command of the control data is a command for instructing acquisition of the display request data, the verification unit verifies whether contents of the display unit, the control command of the display request data and the control command of the control data have a particular relationship or not.

5. The IC card according to claim 1, wherein if the control command of the control data is a command for instructing acquisition of the display request data, the verification unit verifies whether contents of the display unit, the control command of the display request data and the control command of the control data have a particular relationship, and further verifies whether contents of the display request data and contents of display data for display on the display unit acquired by the display control unit match or not.

6. The IC card according to claim 1, wherein
update of the display request data is update of secure data for which authorization is necessary, and
update of the control data is update of non-secure data for which authorization is unnecessary.

7. The IC card according to claim 1, wherein the IC card incorporates an IC chip capable of contactless communication with an external device.

8. A data control method comprising the steps of:
recording display request data for requesting display on a display unit and control data for controlling display on the display unit onto card memory in response to a request from an external device;
verifying data consistency by comparing predetermined control commands contained in the display request data and the control data recorded on the card memory; and
displaying the display request data on the display unit and updating the control data according to a result of the verification.

9. A program causing a computer to function as an IC card comprising:
a recording unit to record display request data for requesting display on a display unit and control data for controlling display on the display unit onto card memory in response to a request from an external device;
a verification unit to verify data consistency by comparing predetermined control commands contained in the display request data and the control data recorded on the card memory; and
a display control unit to display the display request data on the display unit and update the control data according to a verification result by the verification unit.
